(19) United States
(12) Patent Application Publication
(10) Pub. No.: US 2016/0042400 A1
(43) Pub. Date: Feb. 11, 2016

(54) Method of doing business using a cell phone device with locally stored multimedia advertising content

(71) Applicant: Wilfred Nelson, Detroit, MI (US)

(72) Inventor: Wilfred Nelson, Detroit, MI (US)

(21) Appl. No.: 14/887,787

(22) Filed: Oct. 20, 2015

Related U.S. Application Data
(63) Continuation-in-part of application No. 13/872,039, filed on Apr. 26, 2013.
(60) Provisional application No. 61/689,328, filed on Jun. 4, 2012.

(51) Int. Cl. G06Q 30/02

(52) U.S. Cl. CPC G06Q 30/0267

(57) ABSTRACT

A method of doing business for the purpose of generating funds for a cell phone service provider by using a cell phone device with a locally stored multimedia content data bank. The present invention is a new business method of generating funds from registration fees and advertising revenue. In particular, the invention provides a system and method for generating revenue from classified advertisements using mobile and cellular phones by playing an advertisement stored in the cell phone to the user before placing the cell phone call. Advertisements may also be played at intervals during the phone call.

### REFERENCE TO RELATED APPLICATIONS

This is a continuation-in-part of co-pending patent application Ser. No. 13/872,039, entitled “Advertising Method Using A Telephone System”, filed Apr. 26, 2013, which claimed benefit of Provisional Application No. 61/689,328, filed Jun. 4, 2012, entitled “An Advertising Method Using A Telephone System”. The aforementioned applications are hereby incorporated herein by reference.

### BACKGROUND OF THE INVENTION

1. Field of the Invention

The invention pertains to the field of business methods. More particularly, the invention pertains to methods of advertising to users of mobile devices.

2. Description of Related Art

This new business method is being created to solve three problems:

A. Advertisers are running out a ways to advertise. Facebook users switched from PC to smart phones. This renders advertisements too small and ineffective. Cable and broadcast television advertisements are being skipped with these new skip boxes. People are streaming content and data such as movies and television shows directly to smart phones and eliminating advertising altogether. Cellphone advertising in exchange for these cell phone services remedies this situation.

B. Cell phone users have to have cell phones to communicate with the rest of the world, as well as keep in touch with friends and relatives and minor children. The vast majority of the cell phone users are on a tight budget, the regulars cell phone market is expensive and eating into those budgets, causing stress and worries. This causes the need for free cell phone service. Free cell phone service frees up a tight budget and eliminates stress and worries.

C. Free cell phone service can generate for the cell phone provider upwards of three times the revenue by charging advertises instead of cell phone users.

The prior art is exemplified by:

Chavez, Jr. et al. U.S. Pat. No. 6,603,844;

Strietzel U.S. Pat. No. 7,489,768;

Colson et al. U.S. Pat. No. 7,844,485;

Zhang et al. U.S. Pat. No. 7,921,034;

Ramer et al. U.S. Pat. No. 8,103,545;

Ho et al. U.S. Pat. No. 8,135,613;

Oh US Patent Application Publication US 2006/0109969;

Radziewicz et al. US Patent Application Publication US 2006/0285675;

Vitenson et al. US Patent Application Publication US 2007/0116227;

David et al. US Patent Application Publication US 2009/0191852; and

Stifelman et al. US Patent Application Publication US 2010/0027776.

### SUMMARY OF THE INVENTION

With the wide spread adoption of third generation (3G) mobile phone technologies, wireless telephone and implementation of fourth generation (4G) mobile phone technologies, wireless telephone networks are now capable of supporting the transmission of larger amounts of communication devices, to a captive audience with no other choice but to hear the advertisement while their parties are being reached

The present invention is a new business method invented for the purpose of offering cell phone users a free service, free talk, free text, and free data with no monthly bill to pay, in exchange for listening to advertisements. This being accomplished by using a cell phone device with a locally stored multimedia content data bank. The present invention is a new business method of generating funds from registration fees and advertising revenue. In particular, the invention provides a system and method for generating revenue from classified advertisements using mobile and cellular phones by playing an advertisement stored in the cell phone to the user before placing the cell phone call. Advertisements may also be played at intervals during the phone call.

The invention provides a system and method for generating revenue from advertisements over current and future generation wireless networks to portable electronic devices. In particular, the telephone ringing in the caller's ear is replaced with an informative advertisement, targeted to the telephone caller making the call.

This newly invented method embodies the very best way to offer advertisers a captive, direct targeted audience at a reduced costs compared to most advertising methods. This newly invented business method is the best way to offer a cell phone users peace of mind and a budget enhancement by eliminating unnecessary and expensive cost of communicating with the world. This newly invented business method that would generate more revenue for the cell phone provider in any existing method.

It is an object of the present invention to avoid the drawbacks of conventional and present methods, and at the same time to provide a very convenient and easy to use method as described herein.

### BRIEF DESCRIPTION OF THE DRAWING

FIG. 1 shows a block diagram of a system for use with the method of the invention.

FIG. 2 shows a flowchart of the preliminary steps for setting up the method of the invention.

FIG. 3 shows a flowchart of the operation of the method of the invention.

FIG. 4 shows a flowchart of an optional feature of the method of the invention, adding a “like” button to the method.

FIG. 5 shows a cell phone displaying a “like” button.

FIG. 6 shows a cell phone displaying an electronic coupon.

FIG. 7 shows a flowchart of an embodiment of the method of the invention, in which advertisements are played at intervals during a long call.

### DETAILED DESCRIPTION OF THE INVENTION

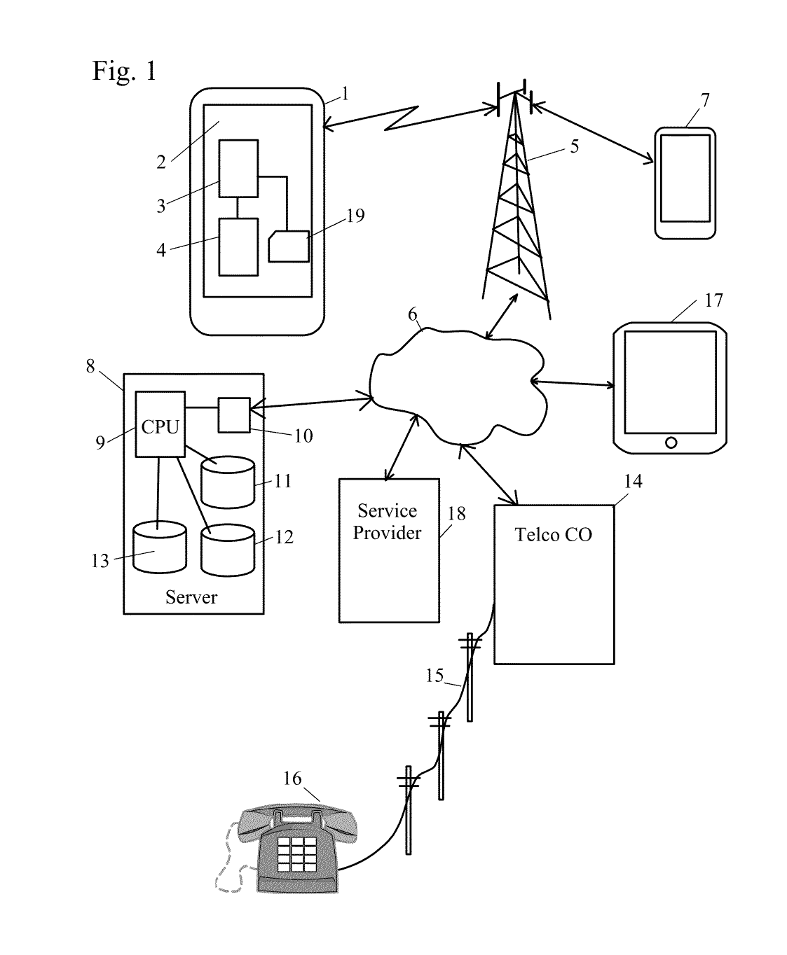

Referring to FIG. 1, a user of the invention has a mobile phone 1 which has a display screen 2, operated by a microprocessor 3 which has access to internal memory 4 which can be used to store advertising files in the form of audio or video or both. A memory card 19, such as a SIM or SD card or other device, is used to identify the cell phone 1 to the cell phone network, as is known to the art.

The mobile phone 1 communicates by radio with cell towers 5 in the area, which are linked through a network 6 such as the Internet, dedicated telephone system networks, satellite links, and any other networks known to the art, to a telephone company central office 14.

The telephone company central office 14 handles billing for the customer as well as routing calls from the mobile phone 1 to other mobile phones 7, or through landlines 15 to wired telephones 16. Calls may also be placed by the mobile phone 1 through the network 6 to computers such as tablet 17, desktop computers or other computer devices, through software programs (“apps”) such as Skype® or FaceTime® or other systems currently known or to be developed. For the purposes of this invention, voice connections which are placed by the user's mobile phone 1 to any sort of other device such as mobile phone 7, wired phone 16, or tablet 17, or other devices, will be referred to as “telephone calls”.

Also connected to network 6 is a server 8, associated with a service provider 18. The server 8 has a processor 9 which is linked to the network 6 by an interface 10. The server 8 processor can access a number of databases such as user database 11, advertiser database 12 and advertisement database 13 as will be seen below. Users in the user database 11 are preferably associated with identification information and demographics as will be explained below, and may also be assigned to categories or classes. Advertisements in the advertisement database 13 will preferably be associated with demographics of target audiences and/or user categories or classes, which may be stored in the advertiser database 12.

The present invention provides an advertisement method in which, when a participating registered user initiates a call from a mobile phone 1 which is enrolled in the method, the telephone call is sent to a cell tower 5 and relayed over the network 6 to service provider 18. The service provider checks a mobile identification number of the caller's telephone device 1, and if the user is registered in the method, relays the telephone call to a computer server 8 which retrieves one or more advertisements from a database 13 and transmits the one or more advertisements through the network 6 and cell tower 5 to the mobile phone 1, which stores the advertisements in its internal memory 4.

### Initial Setup

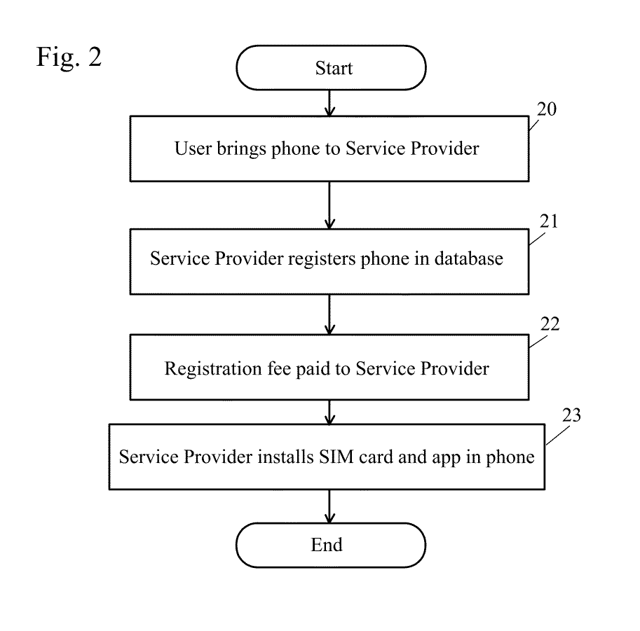

Within the teaching of the invention, the initial preparation for the method is shown in the flowchart of FIG. 2, and comprises the following steps:
Step 20: a cell phone user brings their mobile phone 1 to a service provider 18 who will be offering free or reduced price cell phone service in return for the user agreeing to receive advertisements.
Step 21: The service provider 18 registers the phone number or other identification information assigned to the phone 1 in a user database 11 on the server 8. The service provider 18 may also include demographic information relating to the user—for example, their age, gender, race, social economic status, address or occupation—in the information on the user which is stored in user database 11.
Step 22: After the phone 1 has been registered to the service provider 18, a small registration fee might optionally be paid to the service provider 18.
Step 23: The service provider 18 installs a memory card 19 such as a SIM or SD card into the user's cell phone 1, if necessary replacing a card from a previous provider. The memory card 19 will need to be linked to the user's account in a telephone company 14 for provision of cell services, in a process which is conventional and does not form part of the invention. An application program (app) for running the method will be installed into the memory 4 of the cell phone 1 at the same time, possibly from the memory card 19, or by other means known to the art.

### Operation of the Method

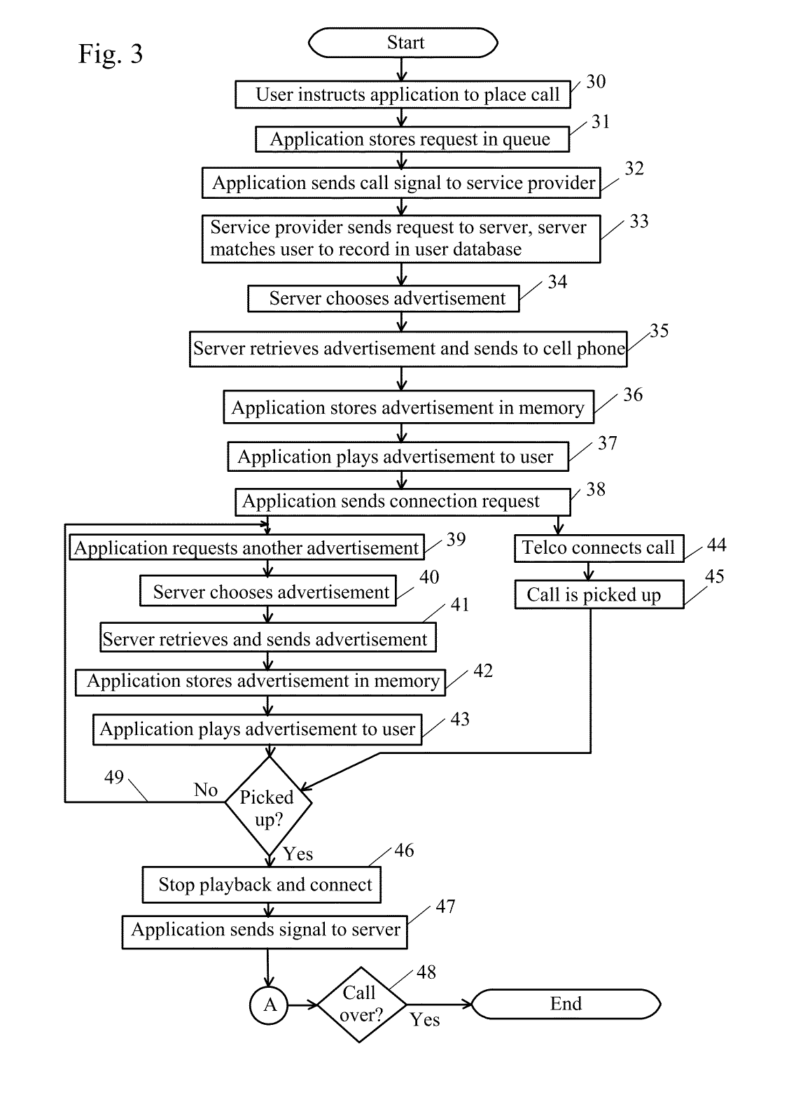

FIG. 3 shows a flowchart of the method of the invention.
Step 30: The cell phone user instructs the application running in the processor 3 of their cell phone 1 to place a phone call. Note that this request may be a call to another user through a phone number, Skype or FaceTime address, etc., or it may be a request to the user's voicemail system to retrieve the user's voice mail messages.
Step 31: The cell phone application running in the microprocessor 3 stores the call request in a queue.
Step 32: The application sends a call signal from the cell phone 1 through the nearest cell tower 5 and network 6 to the service provider 18, providing identification information for the cell phone 1 and requesting initiation of a phone call.
Step 33: The service provider 18 sends a request to the server 8, and the server 8 matches the identification information for the cell phone 1 to identification information registered in the user database 11.
Step 34: Using information provided by the service provider 18, along with information stored on the server 8, such as, for example, the demographic information on the user stored in the user database 11 and advertisement information, target audience links to advertisements, schedules and other information stored in the advertiser database 12, the server 8 chooses an advertisement from the advertisement database 13 which is appropriate for the user.
Step 35: The server 8 retrieves the advertisement from the advertisement database 13 and sends it to the cell phone 1 through the network 6 and cell tower 5.
Step 36: The application running on the microprocessor 3 stores the advertisement in the memory 4 of the cell phone 1.
Step 37: The application running on the microprocessor 3 reads the advertisement from the memory 4 of the cell phone 1 and plays it for the user. This may involve playing an audio recording through the cell phone 1, displaying a video recording on the display screen 2, or both.
Step 38: After the advertisement has fully played, the application running on the microprocessor 3 retrieves a call request from the queue and sends a connection request to the telephone company 14 through the cell tower 5 and network 6. The advertisement may be deleted from memory, or may be retained for further use.
Step 39: The application running on the microprocessor 3 sends a signal to the server 8 to send another advertisement.
Step 40: The server 8 chooses an advertisement from the advertisement database 13 which is appropriate for the user, using the same information as in step 34.
Step 41: The server 8 retrieves the advertisement from the advertisement database 13 and sends it to the cell phone 1 through the network 6 and cell tower 5.
Step 42: The application running on the microprocessor 3 stores the advertisement in the memory 4 of the cell phone 1.
Step 43: The application running on the microprocessor 3 reads the advertisement from the memory 4 of the cell phone 1 and plays it for the user, as in step 37.

In parallel with steps 39-43, the following steps are performed:
Step 44; The telephone company 14 performs the process of connecting the cell phone 1 to the dialed party, for example a wired phone 16, another cell phone 7, or a mobile device such as tablet 17, and the called device rings.
Step 45: The called party (or an answering machine or voice mail system) picks up the call, and the telephone company 14 sends a connection signal to the cell phone 1.
Step 46: If a connection signal is received by the cell phone 1, the application running on the microprocessor 3 stops the playback of the stored advertisement, and the user is connected to the called party or the answering machine or voice mail system.
Step 47: Optionally, the application running on the microprocessor 3 may send a signal to the server 8 to indicate what advertisements were played and, if applicable, that the advertisement was interrupted and how long the advertisement ran. This can be used if advertisers are to be charged based on the time that their advertisements ran, or if they are not charged if their full advertisement did not play.
Step 48: When the call is completed, the method ends.
Step 49: If the advertisement ends and no connection signal has been received, the method repeats from step 39.

### Additional Features and Embodiments

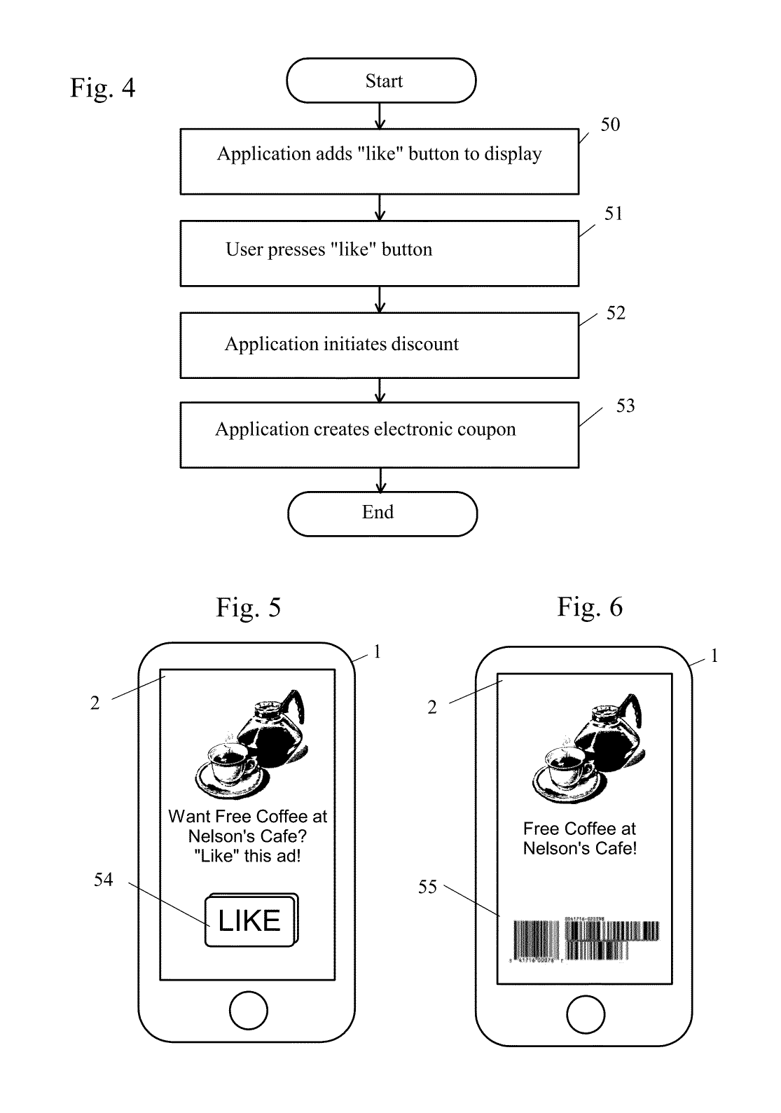

Some additional features and embodiments of the method are shown in FIGS. 4 and 5, which can optionally be integrated into the method of the invention.

### “Like” Button

Through this enhancement, shown in FIGS. 4-6, a user can be given an incentive to listen to advertisements by being able to obtain discounts if he or she “likes” the advertisement. This method can be integrated into steps 37 and 43, above.
Step 50: The application running on the microprocessor 3 can be programmed to add a “like” button 54 on the display 2.
Step 51: If the user hears an advertisement that they like they can press the “like” button on the display 2.
Step 52: In response to the user pressing the “like” button, the application running on the microprocessor 3 initiates a discount associated with the advertisement. The application running on the microprocessor 3 can send a signal to the server 8 to log the selection of the discount. Alternatively, the application running on the microprocessor 3 can store data about the “like” in memory 4.
Step 53: The application running on the microprocessor 3 can create an electronic coupon to be retrieved through the cell phone 1 at the time of purchase. The coupon could, for example, be implemented by having the application running on the microprocessor 3 retrieve a coupon bar code from the memory 4 and display the bar code 55 on the display 2 to be scanned at a checkout register.

### Duration-Based Repeated Advertisements

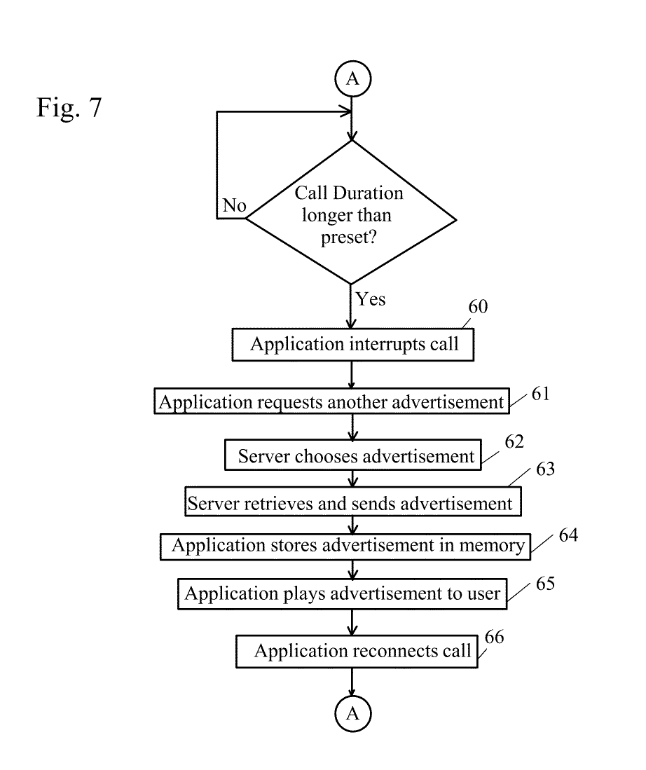

The method of the invention may be modified in this embodiment, as set out in the flowchart of FIG. 7, to play additional advertisements at intervals if the user is engaged in a long phone call. The method of this embodiment would be implemented at connector “A” between steps 47 and 48 of the flowchart in FIG. 3.
Step 60: If the duration of the call exceeds a preset period, for example 15 consecutive minutes, the application running on the microprocessor 3 interrupts the call. A voice message may be sent to the called party, asking them to stand by.
Step 61: The application running on the microprocessor 3 sends a signal to the server 8 to send another advertisement.
Step 62: The server 8 chooses an advertisement from the advertisement database 13 which is appropriate for the user, using the same information as in step 34.
Step 63: The server 8 retrieves the advertisement from the advertisement database 13 and sends it to the cell phone 1 through the network 6 and cell tower 5.
Step 64: The application running on the microprocessor 3 stores the advertisement in the memory 4 of the cell phone 1.
Step 65: The application running on the microprocessor 3 reads the advertisement from the memory 4 of the cell phone 1 and plays it for the user, as in step 37. Alternatively, the application running on the microprocessor 3 may also play the advertisement, or a different advertisement, over the phone call link to the called party.
Step 66: The application running on the microprocessor 3 reconnects the user to the called party and prompts the parties to resume the call.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. An advertisement method using a cell phone, comprising the steps of:
a) an application running on a microprocessor in the cell phone receiving a request from a user to place a phone call;
b) the application running storing the request in a queue;
c) the application sending a call signal to a service provider, providing identification information for the cell phone and requesting initiation of a phone call;
d) the application receiving an advertisement from the service provider;
e) the application storing the advertisement in a memory of the cell phone;
f) the application reading the advertisement from the memory of the cell phone and playing the advertisement for the user; and
g) after the advertisement has fully played, the application retrieving the request from the queue and sending a connection request to a telephone company.

2. The method of claim 1, in which the request in step (a) is to place a call to another user.

3. The method of claim 1, in which the request in step (a) is to access the user's voicemail system to retrieve the user's voice mail messages.

4. The method of claim 1, in which, in step (f), the advertisement is played by playing an audio recording through the cell phone.

5. The method of claim 1, in which, in step (f), the advertisement is played by displaying a video recording on a display screen of the cell phone.

6. The method of claim 1, in which the advertisement is deleted from the memory after the advertisement is played.

7. The method of claim 1, further comprising, after step (g), the steps of:
h) the application requesting an additional advertisement from the service provider;
i) the application storing the additional advertisement in the memory of the cell phone; and
j) the application reading the additional advertisement from the memory of the cell phone and playing the additional advertisement for the user.

8. The method of claim 7, further comprising, after a connection signal is received by the cell phone, the application stopping playing the additional advertisement and connecting the user.

9. The method of claim 7, in which, if a connection signal has not been received when the playing of the additional advertisement is complete, the method repeats from step (h).

10. The method of claim 1, further comprising the step of the application sending a signal to the service provider indicating what advertisement was played.

11. The method of claim 10, in which the signal includes an indication of the length of time the advertisement was played.

12. The method of claim 1, further comprising the steps of:
k) the application displaying a “like” button on a display of the cell phone while playing an advertisement; and
l) in response to the user pressing the “like” button, the application initiating a discount associated with the advertisement.

13. The method of claim 12, in which the step (l) of initiating the discount comprises the application sending a signal to the service provider to log selection of the discount.

14. The method of claim 12, in which the step (l) of initiating the discount comprises the application creating an electronic coupon to be retrieved through the cell phone at time of purchase.

15. The method of claim 14, in which the coupon is created by the steps of:
the application retrieving a coupon bar code associated with the advertisement; and
the application displaying the coupon bar code on the display of the cell phone to be scanned at a checkout register.

16. The method of claim 1, further comprising the step of the application tracking the duration of the connection between the user and a called party.

17. The method of claim 16, further comprising the steps, after the application has determined that the duration of the connection has exceeded a predetermined duration:
the application requesting an additional advertisement from the service provider;
the application storing the additional advertisement in the memory of the cell phone;
the application reading the additional advertisement from the memory of the cell phone and playing the additional advertisement for the user; and
the application reconnecting the user and the called party after playing the additional advertisement.

18. The method of claim 17, further comprising the application playing the advertisement for the called party.
